(19) United States
(12) Patent Application Publication
(10) Pub. No.: US 2018/0329557 A1
(43) Pub. Date: Nov. 15, 2018

(54) HYBRID TOUCH CONTROL METHOD

(71) Applicant: PixArt Imaging Inc., Hsin-Chu City (TW)

(72) Inventor: Chia-Yi Lee, Hsin-Chu City (TW)

(21) Appl. No.: 15/595,918

(22) Filed: May 15, 2017

(51) Int. Cl. G06F 3/041; G06F 3/044

(52) U.S. Cl. CPC G06F 3/0414; G06F 3/044; G06F 3/0416

(57) ABSTRACT

An hybrid touch control method applied to an electronic apparatus comprising a touch interface. The hybrid touch control method comprises: (a) sensing if an object presses the touch interface to generate a pressure sensing signal; (b) sensing if the object touches the touch interface to generate a touch sensing signal; and (c) controlling the electronic apparatus according to the pressure sensing signal, but not according to the touch sensing signal. The step (c) can be replaced by: maintain or to stop an operation that the electronic apparatus is performing according to the pressure sensing signal if the touch sensing signal indicates the object is in a predetermined region of the touch interface. Via such method, the electronic apparatus can still be well controlled even if the touch is performed to a region that is not sensitive to touch.

### BACKGROUND OF THE INVENTION

### 1. Field of the Invention

The present invention relates to a hybrid touch control method, and particularly relates to a hybrid touch control method control method which can control an electronic apparatus according to pressure sensing when a touch event is not detectable.

### 2. Description of the Prior Art

Recently, an electronic apparatus with a touch control function becomes more and more popular. A user can apply an object such as a finger or a stylus to control the electronic apparatus via a touch interface. However, the conventional touch control method has some shortcomings.

FIG. 1 is a schematic diagram illustrating that the object is touching an edge region of the electronic apparatus. As illustrated in FIG. 1, the electronic apparatus 100 has a touch interface 101 (ex. a touch screen). A user can use an object (ex. user's finger F) to perform a gesture on the touch interface 101 to control the electronic apparatus 100. Therefore, the electronic apparatus 100 has a touch sensor (not illustrated here) to sense the touch performed on the touch interface 101.

However, the touch sensor is always not sensitive in some regions such as edge regions. Thus, the finger F may not be sensed even if the finger F touches the touch interface 101 in such regions. As illustrated in FIG. 1, the finger F touches an edge region E of the electronic apparatus 100, and the finger F cannot be sensed by the touch sensor due to the non-sensitivity of the touch sensor. Accordingly, the user cannot control the electronic apparatus 100 if the gesture is performed to the edge region E.

### SUMMARY OF THE INVENTION

One objective of the present invention is to provide an hybrid touch control method which can well control the electronic apparatus even if the touch is performed to a region that is not sensitive to touch.

Another objective of the present invention is to provide an electronic apparatus which can be well controlled even if the touch is performed to a region that is not sensitive to touch.

One embodiment of the present invention provides a hybrid touch control method applied to an electronic apparatus comprising a touch interface. The hybrid touch control method comprises: (a) sensing if an object presses the touch interface to generate a pressure sensing signal; (b) sensing if the object touches the touch interface to generate a touch sensing signal; and (c) controlling the electronic apparatus according to the pressure sensing signal, but not according to the touch sensing signal.

Another embodiment of the present invention discloses a hybrid touch control method, applied to an electronic apparatus comprising a touch interface. The method comprises: (a) sensing if an object presses the touch interface, to accordingly generate a pressure sensing signal; (b) sensing if the object touches the touch interface, to accordingly generate a touch sensing signal; (c) performing an operation according to the touch sensing signal; and (d) maintaining or stopping the operation according to the pressure sensing signal if the touch sensing signal indicates the object does not touch the touch interface.

Still another embodiment of the present invention discloses a hybrid touch control method, applied to an electronic apparatus comprising a touch interface, comprising: sensing if an object presses the touch interface, to accordingly generate a pressure sensing signal; sensing if the object touches the touch interface, to accordingly generate a touch sensing signal; and maintaining or stopping an operation that the electronic apparatus is performing according to the pressure sensing signal but not according to the touch sensing signal if the touch sensing signal indicates the object is in a predetermined region of the touch interface.

In view of above-mentioned embodiments, the electronic apparatus can still be well controlled even if the touch is performed to a region that is not sensitive to touch. Accordingly, the issue mentioned for a conventional touch control function can be solved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating that the object is touching an edge region of the electronic apparatus.

FIG. 2A is a block diagram illustrating an electronic apparatus according to one embodiment of the present invention.

FIG. 2B is a schematic diagram illustrating a top view of the electronic apparatus illustrated in FIG. 2B.

FIG. 3 and FIG. 4 are schematic diagrams illustrating the hybrid touch control method according to one embodiment of the present invention.

FIG. 5 and FIG. 6 are schematic diagram illustrating the hybrid touch control method according to another embodiment of the present invention.

FIG. 7 is a flow chart illustrating an hybrid touch control method according to one embodiment of the present invention.

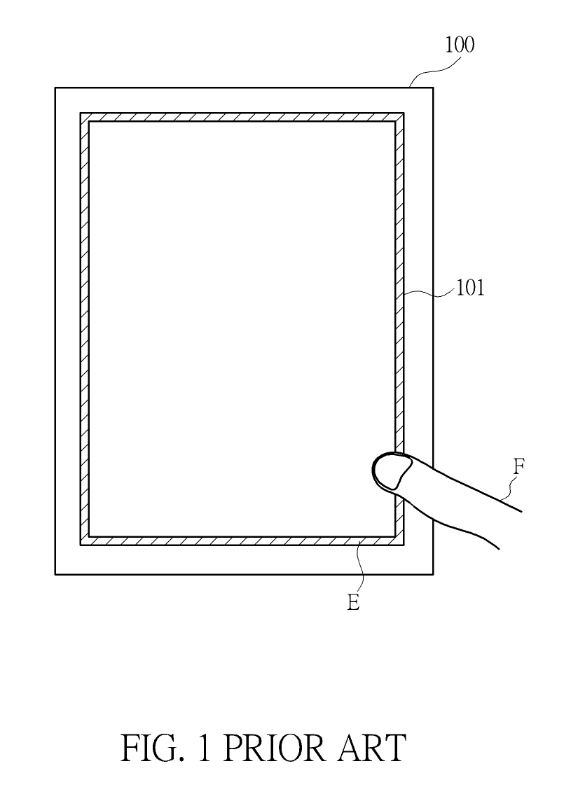

### DETAILED DESCRIPTION

In following descriptions, several embodiments are provided to explain the concept of the present invention. Please note the elements mentioned in these embodiments can be implemented by hardware (ex. a circuit) or hardware with software (ex. a processing unit with a program).

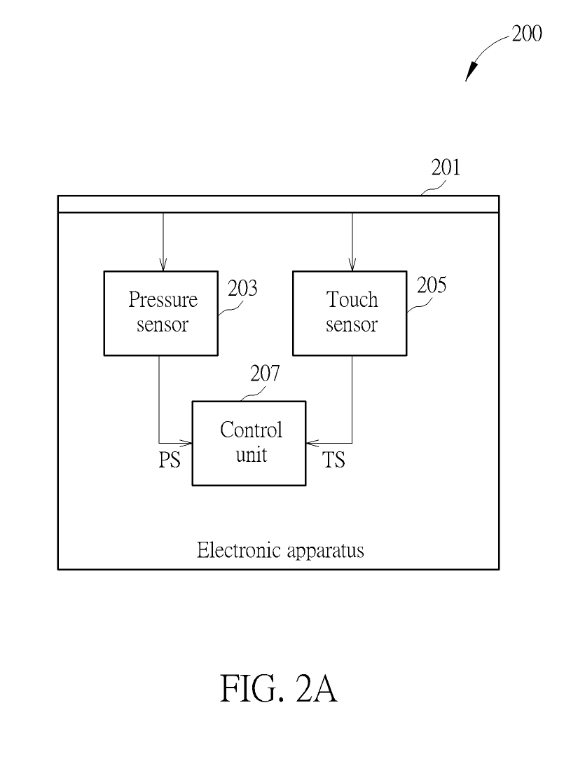

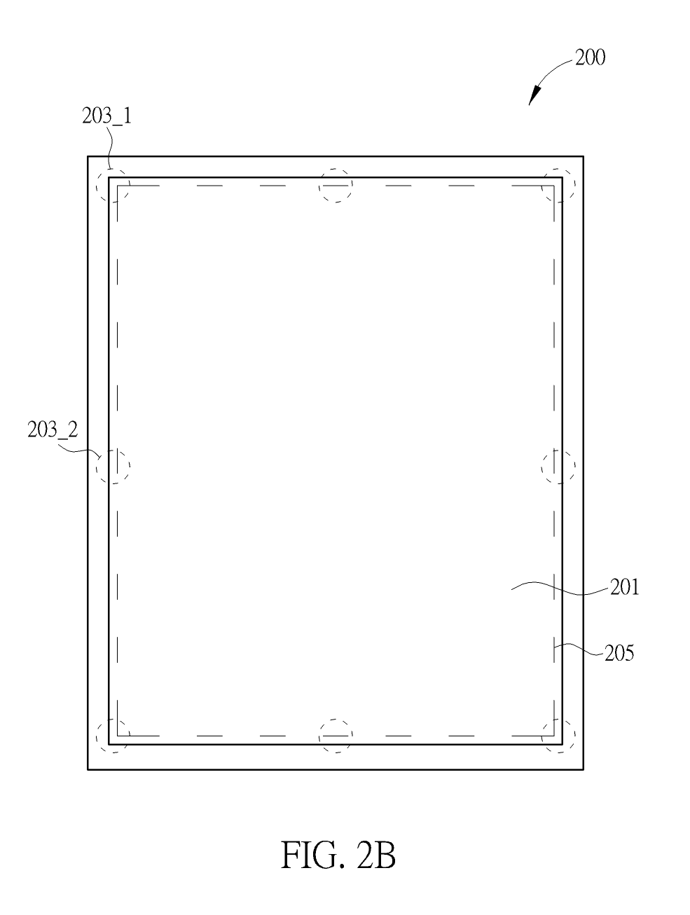

FIG. 2A is a block diagram illustrating an electronic apparatus according to one embodiment of the present invention. As illustrated in FIG. 2A, the electronic apparatus 200 comprises a touch interface 201, a pressure sensor 203, a touch sensor 205 and a control unit 207. The touch interface 201 is an interface on which a user can perform a gesture, such as a swipe or a tap, to control the electronic apparatus 200. The pressure sensor 203 is coupled to the touch interface 201, to sense if an object presses the touch interface 201 (i.e. if a press event exists), to accordingly generate a pressure sensing signal PS. The touch sensor 205 is coupled to the touch interface 201, to sense if the object touches the touch interface 201 (i.e. if a touch event exists), to accordingly generate a touch sensing signal TS. The control unit 207 is coupled to the pressure sensor 203 and the touch sensor 205 to receive the pressure sensing signal PS and the touch sensing signal TS. In one embodiment, the touch sensing signal TS indicates a coordinate of the touch interface 201 and/or a gesture performed to the touch interface 201. Please note, the touch event can mean really touch the touch interface 201, but can mean “close” to the touch interface 201 as well.

In one embodiment, the touch sensor 205 generates a touch sensing signal TS indicating a touch event exists if the touch event occurs on the touch interface, and generates a touch sensing signal TS indicating the touch event does not exist if the touch event does not occur on the touch interface. In another embodiment, the touch sensor 205 generates the touch sensing signal TS if a touch event occurs on the touch interface 201 and does not generate the touch sensing signal TS if a touch event occurs on the touch interface 201. The pressure sensor 203 also has the same operation, the descriptions thereof is omitted for brevity here.

FIG. 2B is a schematic diagram illustrating a top view of the electronic apparatus illustrated in FIG. 2B. In other words, FIG. 2B is a schematic diagram illustrating one example for the arrangement of the components illustrated in FIG. 2A. Please note the arrangement illustrated in FIG. 2B is only an example and does not mean to limit the scope of the present application. Also, several pressure sensors are provided in FIG. 2B, but only two of the pressure sensors 203_1, 203_2 are symbolized for explanation.

As illustrated in FIG. 2B, the touch sensor 205 is provided under the touch interface 201, to sense the touch event on the touch interface 201. Also, at least one pressure sensor 203 is provided under the touch interface 201, to sense the pressure event on the touch interface 201.

The touch interface 201 is any interface on which a user can perform a control command through the pressure sensor 203 or touch sensor 205, for example, a touch screen or a touch pad. The pressure sensor 203 and the touch sensor 205 are well known devices. For example, the US application with a publication number US 20170038900 also illustrates a pressure sensor and a touch sensor.

In one embodiment, the touch interface 201 comprises at least one pixel. The capacitance of the pixel changes if any conductive object (ex. a finger) touches or close to the pixel. The touch sensor 205 can sense the capacitance variation to generate the touch sensing signal TS, which means if any touch event occurs. Besides, in one embodiment, the pressure sensor 203 senses the press event caused by an external force provided to the touch interface 201. For example, the pressure sensor comprises a plurality of sensing units having at least two sides of the electrodes. The external force can cause different sides of the electrodes to be closer, thus the capacitance caused by the electrodes changes. Accordingly, the pressure sensor 203 generates the pressure sensing signal PS according to the capacitance variation.

In one embodiment, the control unit 207 performs a control operation to control the electronic apparatus 200 according to the at least one of the pressure sensing signal PS and according to the touch sensing signal TS. In another embodiment, while a control operation is performed based on the touch sensing signal TS, the control unit 207 maintains or stop the control operation based on the pressure sensing signal PS when the control unit 207 loss touch event based on the touch sensing signal TS (i.e. no touch is sensed on the touch interface 201).

In following descriptions, several examples are provided to explain the operations for the electronic apparatus provided by the embodiment of the present invention. It will be appreciated that, in following examples, a finger is taken as an example for the object, but the object is not limited to a finger.

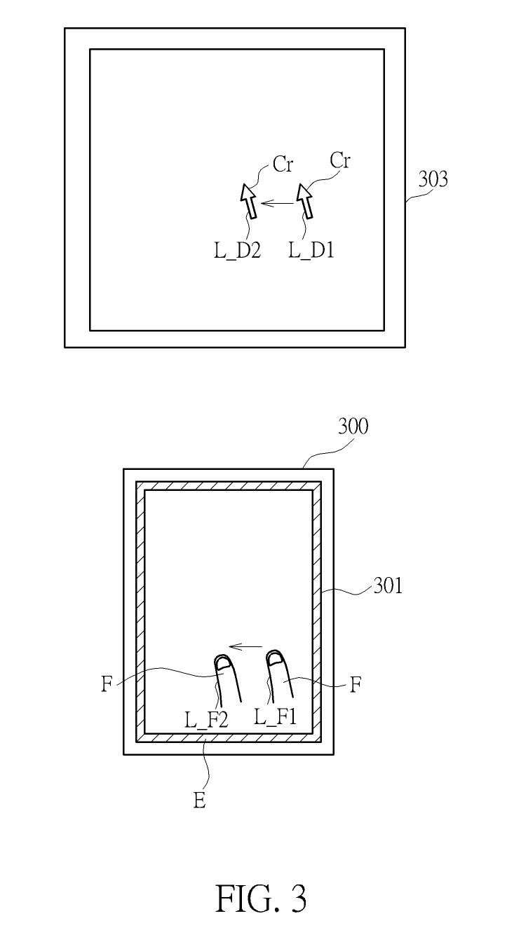

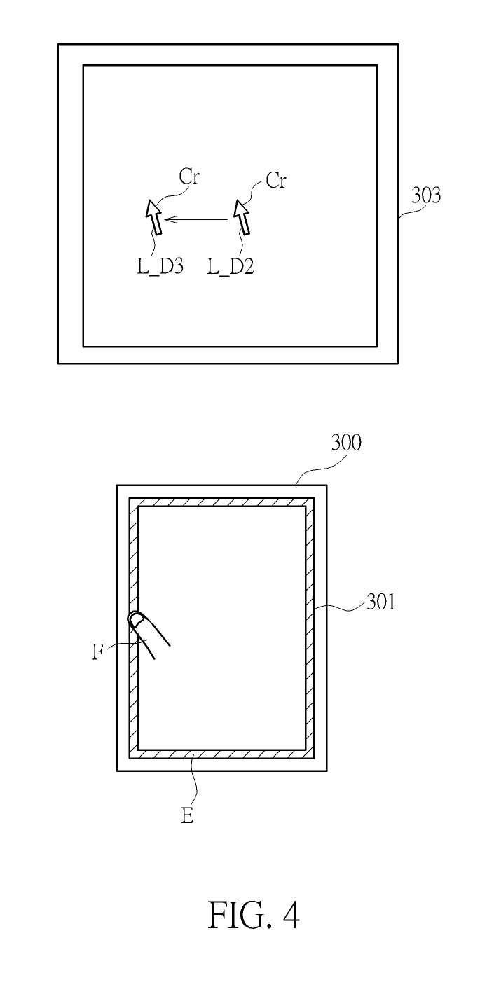

FIG. 3 and FIG. 4 are schematic diagrams illustrating the hybrid touch control method according to one embodiment of the present invention. As illustrated in FIG. 3, an electronic apparatus 300 with a touch interface 301 is provided. A user uses his finger F to swipe on the touch interface 301, from a location L_F1 to another location L_F2. The control unit 207 controls the display 303 to display the cursor Cr (i.e. the control operation). In such case, the cursor Cr moves on the display 303 corresponding to the movement of the finger F, from a location L_D1 to another location L_D2. In one embodiment, the display 303 and the touch interface 301 are combined to a single device such as a touch screen. In another embodiment, the display 303 and the control interface 301 are different devices.

As above-mentioned, the touch sensor 205 is always non-sensitive in some regions such as edge regions. Thus, the finger F may not be sensed even if the finger F touches the touch interface 101 in such regions, which means the control unit 207 losses the touch event. Accordingly, in such case the touch event can be sensed even if the finger F touches an edge region E that is a low sensitivity or not sensible for the touch sensor 205.

Please refer to FIG. 4, the finger F moves to the edge region E of the electronic apparatus 300, thus the finger F probably is not sensed and so the touch event is lost even if the finger F still touches touch interface 301. Please note, practically, the edge region E may not be particularly displayed on the touch interface 301. The edge region E illustrated in FIG. 3 and FIG. 4 is only for the convenience of explaining. In that case, the above mentioned touch sensing signal TS indicates that the finger F does not touch the touch interface 301 (i.e. the touch event is not sensed) but the pressure sensing signal PS indicates that the finger F still presses the touch interface 301 (i.e. the press event is sensed). In such case, the electronic apparatus 300 is controlled according to the pressure sensing signal PS but not according to the touch sensing signal TS. In one embodiment, the operation that the electronic apparatus 300 performs before the touch of the finger F is not sensed is maintained if the touch event is not sensed but the press event is sensed. For more detail, the control unit 207 is performing a control operation based on the touch event, but suddenly losses the touch event. In such case, the control unit 207 can maintain the control operation based on the pressure sensing signal PS if the pressure sensing signal PS still indicates the press event exists.

For example, as illustrated in FIG. 3, the cursor Cr moves to the left (from a location L_D1 to the location L_D2), and in FIG. 4 the cursor Cr still keeps moving to the left (from a location L_D2 to the location L_D3) if the touch event is not sensed but the press event is sensed. In one embodiment, the cursor Cr can move from the location L_D2 to the location L_D3 in an original direction and at an original speed that it moved from the location L_D1 to the location L_D2, until the press event is not sensed or until it reach a border of the touch interface 301. In another embodiment, the cursor Cr can move from the location L_D2 to the location L_D3 in a predetermined direction and at a predetermined speed, until the press event is not sensed or until it reach a border of the touch interface 301.

In another embodiment, the operation that the electronic apparatus 300 is performing is maintained or stopped according to the pressure sensing signal PS if the touch sensing signal TS indicates the finger F is in an edge region of the touch interface 301. More specifically, once the finger F moves to the edge region E, the operation that the electronic apparatus 300 is performing is maintained or stopped according to the pressure sensing signal PS even if the touch of the finger F is sensed.

In one embodiment, the operation that the electronic apparatus 300 performs before the finger F touches the edge region E is maintained if the finger F touches the edge region E and the press of the finger is sensed. For example, in FIG. 3, the cursor Cr moves to the left (from a location L_D1 to the location L_D2), and in FIG. 4 the cursor Cr still keeps moving to the left (from a location L_D2 to the location L_D3) if the finger F touches the edge region E and the press of the finger is sensed.

The edge region E can be defined by various methods. For example, a predetermined range comprising the edge of the touch interface 301 can be defined as the edge region E. Alternatively, in another embodiment, a region of the touch interface 301 on which only a part of the finger F can press the touch interface 301 is defined as the edge region E. Additionally, the edge region illustrated in above-mentioned embodiments can be replaced by any other predetermined region of the touch interface.

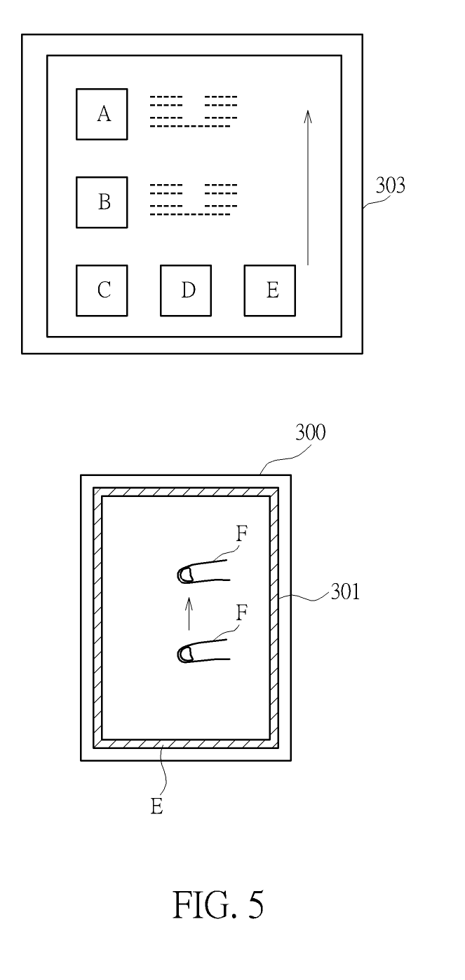

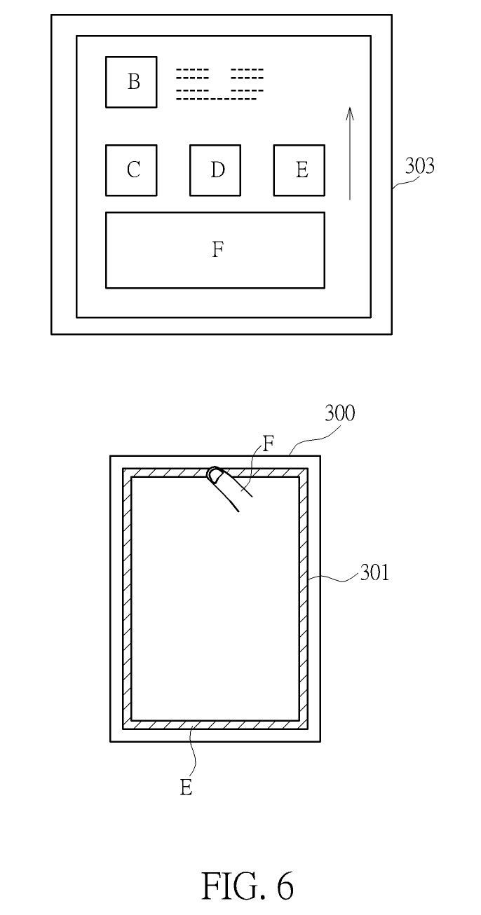

FIG. 5 and FIG. 6 are schematic diagram illustrating the hybrid touch control method according to another embodiment of the present invention. In the example of FIG. 5, the user moves up the finger F, and the web page displayed on the display 303 scrolls up corresponding to movement of the finger F. In the example of FIG. 6, according to the illustration for FIG. 3 and FIG. 4, the web page still keeps scrolling up even if the finger F moves to the edge region E. Details for the embodiments illustrated in FIG. 5 and FIG. 6 can be understood based on the embodiments illustrated in FIG. 3 and FIG. 4, thus are omitted for brevity here.

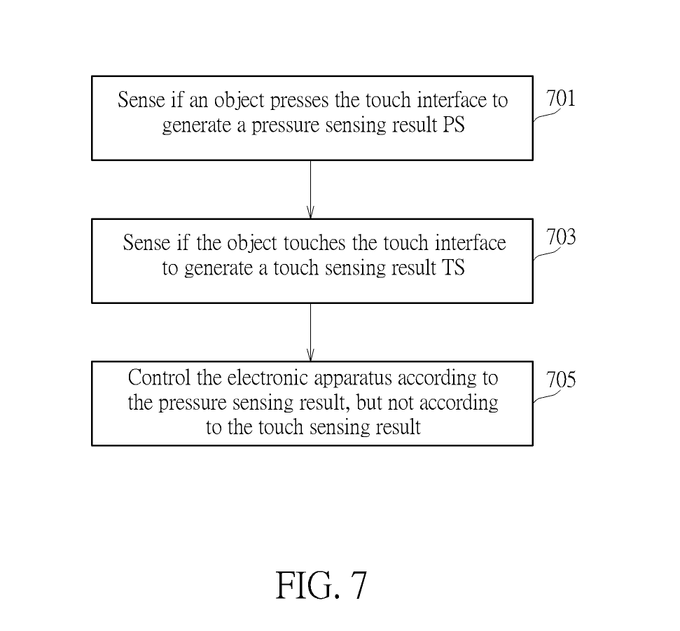

FIG. 7 is a flow chart illustrating an hybrid touch control method according to one embodiment of the present invention, which is applied to an electronic apparatus comprising a touch interface. The hybrid touch control method in FIG. 7 comprises following steps:

### Step 701

Sense if an object presses the touch interface to generate a pressure sensing signal (ex. PS in FIG. 2).

### Step 703

Sense if the object touches the touch interface to generate a touch sensing signal (ex. TS in FIG. 2).

### Step 705

Control the electronic apparatus according to the pressure sensing signal, but not according to the touch sensing signal. For example, the cursor Cr in FIG. 4 keeps moving if the touch event is not sensed but the press event is sensed.

In one embodiment, the step 705 is replaced by: maintaining or stopping an operation that the electronic apparatus is performing according to the pressure sensing signal PS if the touch sensing signal TS indicates the finger F is in a predetermined region of the touch interface (ex. the edge region E in FIG. 4).

Other detail steps for the hybrid touch control method can be acquired in view of above-mentioned embodiments, thus descriptions thereof are omitted for brevity here.

The above-mentioned electronic control methods can be applied to any kinds of electronic apparatuses. However, the above-mentioned electronic control methods are particularly advantageous to an electronic apparatus with a small touch interface, such as a smart watch or a smart bracelet, or any other wearable electronic apparatus.

In view of above-mentioned embodiments, the electronic apparatus can still be well controlled even if the touch is performed to a region that is not sensitive to touch. Accordingly, the issue mentioned for a conventional touch control function can be solved.

Those skilled in the art will readily observe that numerous modifications and alterations of the device and method may be made while retaining the teachings of the invention. Accordingly, the above disclosure should be construed as limited only by the metes and bounds of the appended claims.

1. An hybrid touch control method, applied to an electronic apparatus comprising a touch interface, comprising:
(a) sensing if an object presses the touch interface to generate a pressure sensing signal;
(b) sensing if the object touches the touch interface to generate a touch sensing signal; and
(c) controlling the electronic apparatus according to the pressure sensing signal, but not according to the touch sensing signal while the touch sensing signal indicates the object does not touch the touch interface.

2. The hybrid touch control method of claim 1, wherein the step (c) is performed while the pressure sensing signal indicates that the object presses the touch interface.

3. The hybrid touch control method of claim 1, wherein the step (c) is performed while the object presses an edge region of the touch interface.

4. The hybrid touch control method of claim 1, wherein the step (c) is performed while only a part of the object presses the touch interface.

5. The hybrid touch control method of claim 1, wherein the step (c) controls the electronic apparatus to maintain the operation being performed while the pressure sensing signal indicates that the object presses the touch interface.

6. The hybrid touch control method of claim 5, wherein the touch interface is a touch screen, wherein the step (c) controls the electronic apparatus to keep moving a cursor if the object originally moves on the touch interface to move the cursor, while the pressure sensing signal indicates the object presses the touch interface.

7. The hybrid touch control method of claim 1, wherein the electronic apparatus is a wearable electronic apparatus.

8. The hybrid touch control method of claim 7, wherein the electronic apparatus is a smart watch or a smart bracelet.

9. A hybrid touch control method, applied to an electronic apparatus comprising a touch interface, comprising:
(a) sensing if an object presses the touch interface, to accordingly generate a pressure sensing signal;
(b) sensing if the object touches the touch interface, to accordingly generate a touch sensing signal;
(c) performing an operation according to the touch sensing signal; and
(d) maintaining or stopping the operation according to the pressure sensing signal if the touch sensing signal indicates the object does not touch the touch interface.

10. The hybrid touch control method of claim 9, wherein the operation is moving a cursor.

11. The hybrid touch control method of claim 9, wherein the step (d) maintains the operation according to the pressure sensing signal if the touch sensing signal indicates the object does not touch the touch interface but the press sensing signal indicates the object presses the touch interface.

12. A hybrid touch control method, applied to an electronic apparatus comprising a touch interface, comprising:
sensing if an object presses the touch interface, to accordingly generate a pressure sensing signal;
sensing if the object touches the touch interface, to accordingly generate a touch sensing signal; and
maintaining or stopping an operation that the electronic apparatus is performing according to the pressure sensing signal but not according to the touch sensing signal if the touch sensing signal indicates the object is in a predetermined region of the touch interface.

13. The hybrid touch control method of claim 12, wherein the predetermined region is non-sensitive to a touch event, wherein the touch event does not comprise a pressure event.

14. The hybrid touch control method of claim 13, wherein the predetermined region is an edge region of the touch surface.
